(19) United States
(12) Patent Application Publication
(10) Pub. No.: US 2014/0042752 A1
(43) Pub. Date: Feb. 13, 2014

(54) METHOD AND SYSTEM TO GENERATE ELECTRICITY

(71) Applicant: Marcus McDermott, Lake Worth, FL (US)

(72) Inventor: Marcus McDermott, Lake Worth, FL (US)

(21) Appl. No.: 13/570,450

(22) Filed: Aug. 9, 2012

(51) Int. Cl. H02K 7/18

(52) U.S. Cl. 290/1 R; 310/67 R

(57) ABSTRACT

A system to generate electricity is disclosed. In a particular embodiment, the system includes a sleeve configured to be secured to an inside of a wheel rim, where the sleeve rotates with a rotation of the wheel rim. A plurality of permanent magnets are mounted to an inside surface of the sleeve, where a polarity of each magnet is opposite to an adjacent magnet. The system also includes an annular core configured to slide into the sleeve and be secured to a portion of a vehicle, where the core is stationary relative to the rotation of the sleeve. Coils are mounted about an outer surface of the annular core in proximity to the plurality of permanent magnets. Accordingly, electrical output is generated as the permanent magnets provide a magnetic flux to the plurality of coils as the sleeve rotates.

### I. FIELD

The present invention relates in general to a method and system to generate electricity.

### II. DESCRIPTION OF RELATED ART

An alternator is typically used in combustion engine type vehicles to continually charge the vehicle's battery. The alternator includes a stator, rotor, diode and a voltage regulator. The rotor inside the alternator spins when the alternator belt spins the pulley on the alternator. The rotor includes a magnet or group of magnets that spin inside a stator consisting of windings of copper wires, which produces electricity. A diode assembly converts the electricity from AC to DC current that a typical battery can use. A voltage regulator is used to protect the battery from being overcharged and damaged.

In electric or hybrid vehicles, regenerative braking may be used to charge the battery. Regenerative braking is a system in which the electric motor that normally drives an electric or hybrid vehicle is operated in reverse during braking or coasting. Instead of consuming energy to drive a vehicle, the motor acts as a generator that charges the vehicle's batteries with electrical energy that would normally be lost as heat through traditional mechanical friction brakes. As the motor “acts in reverse,” it generates electricity. The accompanying friction assists the normal brake pads in overcoming inertia and helps slow the vehicle.

Electric and hybrid vehicles use a completely different method of braking at slower speeds. Hybrid vehicles still use conventional brake pads at highway speeds, but electric motors help the vehicle brake during stop-and-go driving at slower speeds. As the brakes are applied by pressing down on a conventional brake pedal, the electric motors reverse direction. The torque created by this reversal counteracts the forward momentum and eventually stops the car.

Therefore, a need exists in the art for a method and system to generate electricity efficiently in combustion engine type vehicles not only when a vehicle is braking, but in the normal operation of the vehicle when moving.

However, in view of the prior art at the time the present invention was made, it was not obvious to those of ordinary skill in the pertinent art how the identified needs could be fulfilled.

### III. SUMMARY

In a particular embodiment, a system to generate electricity is disclosed. The system includes a sleeve configured to be secured to an inside of a wheel rim, where the sleeve rotates with a rotation of the wheel rim. A plurality of permanent magnets are mounted to an inside surface of the sleeve, where a polarity of each magnet is opposite to an adjacent magnet. The system also includes an annular core configured to slide into the sleeve and be secured to a portion of a vehicle, where the core is stationary relative to the rotation of the sleeve. A plurality of coils are mounted about an outer surface of the annular core in proximity to the plurality of permanent magnets, where electrical output is generated as the permanent magnets provide a magnetic flux to the plurality of coils as the sleeve rotates.

In another particular embodiment, a plurality of permanent magnets are mounted to an inside surface of a wheel rim, where a polarity of each magnet is opposite to an adjacent magnet. An annular core is configured to slide into the rim and be secured to a portion of a vehicle, where the core is stationary relative to the rotation of the rim. A plurality of coils are mounted about an outer surface of the annular core in proximity to the plurality of permanent magnets and electrical output is generated as the permanent magnets provide a magnetic flux to the plurality of coils as the rim rotates. Each of the coils includes first windings, second windings and third windings to output three-phase electricity. At least one roller bearing may be disposed between the rim and the annular core to maintain a desired distance between the plurality of magnets and the plurality of coils as the rim rotates about the annular core. An anti-rotation plate secured to the vehicle and the back plate prevents the annular core from rotating.

In yet another particular embodiment, a method to generate electricity is disclosed. The method includes securing a plurality of permanent magnets to an inside surface of a sleeve configured to fit inside a wheel rim of a vehicle, where a polarity of each magnet is opposite to an adjacent magnet. The method also includes securing a plurality of coils about an outer surface of an annular core in proximity to the plurality of permanent magnets, where the coils are stationary relative to the rotation of the rim. In addition, the method includes generating electrical output by rotating the permanent magnets about the plurality of coils to provide a magnetic flux to the plurality of coils.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a perspective exploded view of a particular embodiment of the system to generate electricity;

FIG. 2 is an elevational view of coils and permanent magnets installed within a wheel rim, with some elements removed from the system for clarity;

FIG. 3 is a sectional view taken along line 3-3 of FIG. 2;

FIG. 4 is an elevational view of an alternative embodiment of a system to generate electricity; and

FIG. 5 is a sectional view taken along line 5-5 of FIG. 4, and illustrating the coils wrapped around a core.

### V. DETAILED DESCRIPTION

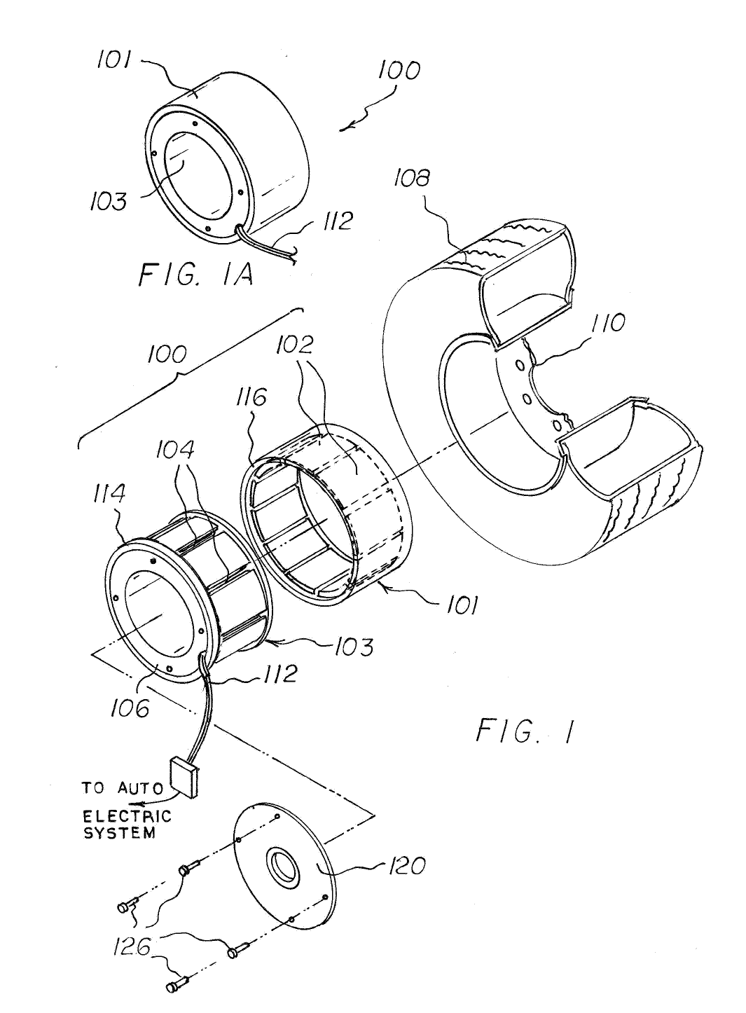

A system to generate electricity is disclosed and generally designated 100. Referring now to FIG. 1, the system 100 includes a sleeve 101 configured to be secured to an inside of a wheel rim 110 of a vehicle such as a car, truck, or golf cart, for example. The system 100 is configured to be installed in many types of rims including an original equipment manufacturer (OEM) wheel rim 110 as a retrofit, or the system may be integrated and fabricated directly into the wheel rim 110 itself.

The sleeve 101 rotates with a rotation of the wheel rim 110. A plurality of permanent magnets 102 are mounted to an inside surface of the sleeve 101, where a polarity of each magnet is opposite to an adjacent magnet. The sleeve 101 may be compression fit into the rim 110, welded, or any other similar means to secure the sleeve 101 to the rim 110. The magnets 102 may also be secured directly to the inside of the rim 101, however, the use of a sleeve 101 allows the magnets to be more securely fastened to the rim 110.

An annular core 103 is configured to slide into the sleeve 101 and be secured to a portion of the vehicle. The core 103 is stationary relative to the rotation of the sleeve 101 and rim 110. A plurality of coils 104 are mounted about an outer surface of the annular core 103 in proximity to the plurality of permanent magnets 102. Accordingly, an electrical output is generated as the permanent magnets 102 provide a magnetic flux to the plurality of coils 104 as the sleeve 101 and magnets 102 rotate with the rim 110. A circuit board 128 may be in electrical communication with the plurality of coils 102 via wires 112 and an electrical system of the vehicle. As shown in FIG. 1A, the stationary annular core 103 fits inside the rotating sleeve 101.

The annular core 103 may include a back plate 106 that extends beyond the periphery of the annular core 103 and is used to protect the coils 102 and bearings. An anti-rotation plate 120 may be secured to the vehicle (not shown) and the back plate 106 to prevent the annular core 103 from rotating. The sleeve 101 is sealed against the back plate 106.

In a particular embodiment, the coils 104 each further comprise first windings, second windings and third windings. These windings are interleaved with each other to produce three currents that make up the three phases that are output through wires 112. Adding all three together produces the total AC output. The plurality of coils 104 may be arranged in a circular array to project outward from the annular core 103.

At least one roller bearing is disposed between the sleeve 101 and the annular core 104 to maintain a desired distance between the plurality of magnets 102 and the plurality of coils 104 as the sleeve 101 rotates about the annular core 103. As illustrated in FIG. 3A, the roller bearing may include a ball bearing retaining inner raceway 116 disposed on the inside surface of the sleeve 101 and an outer raceway 114 disposed on the outer surface of the annular core 103. The raceways 114, 116 in the ball bearing are the circular grooves formed in the outside surface of the annular core 103 and in the inside surface of the sleeve 101. When the raceways 114, 116 are aligned, these grooves form a circular track that contains the ball set 115. Ball bearings 115 can support moderate radial loads and moderate axial loads (parallel to the shaft). They can operate at high speeds. Ball bearings 115 with shields or seals for protection are usually lubricated to last for the operating life.

The track diameter and track radius are two dimensions that define the configuration of each raceway 114, 116. Track diameter is the measurement of the diameter of the imaginary circle running around the deepest portion of the raceway, whether it is an inner or outer groove. This measurement is made along a line perpendicular to, and intersecting, the axis of rotation. Track radius describes the cross section of the arc formed by the raceway groove. It is measured when viewed in a direction perpendicular to the axis of the raceway groove. In the context of ball bearing terminology, track radius has no mathematical relationship to track diameter.

Referring now to FIG. 3, a rubber seal and/or spacer may be inserted between the anti-rotation plate 120 and an axle 124 of the vehicle. Shields and seals are necessary to provide optimum ball bearing life by retaining lubricants and preventing contaminants from reaching central work surfaces. The annular core 103 may also be secured to the axle 124 of the vehicle so that the system 100 system all moves together with the vehicle to increase shock absorption. The anti-rotation plate may be secured to the axle 124 with a half shell 122 and a stabilizing clamp.

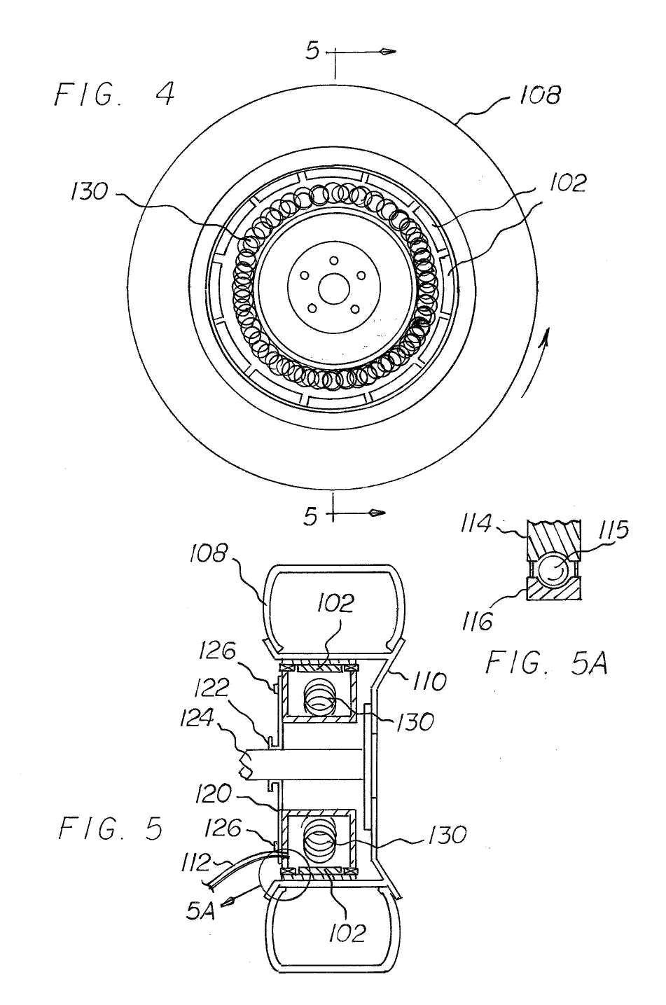

In another particular embodiment, three windings 130 are wrapped around a periphery of the annular core 103 as shown in FIGS. 4 and 5, and the windings 130 remain stationary relative to a rotation of the wheel rim 110. These windings overlap each other in phase angle, or timing relationship, by 120 degrees with respect to each other. The three windings produce three currents that make up the three phases that are output through wires 112. Adding all three together produces the total AC output. The permanent magnets 102 are mounted to an inside surface of the sleeve 101, where a polarity of each magnet is opposite to an adjacent magnet. Thus, an electrical output is generated as the permanent magnets 102 provide a magnetic flux to the windings 130 as the sleeve 101 and magnets 102 rotate with the rim 110.

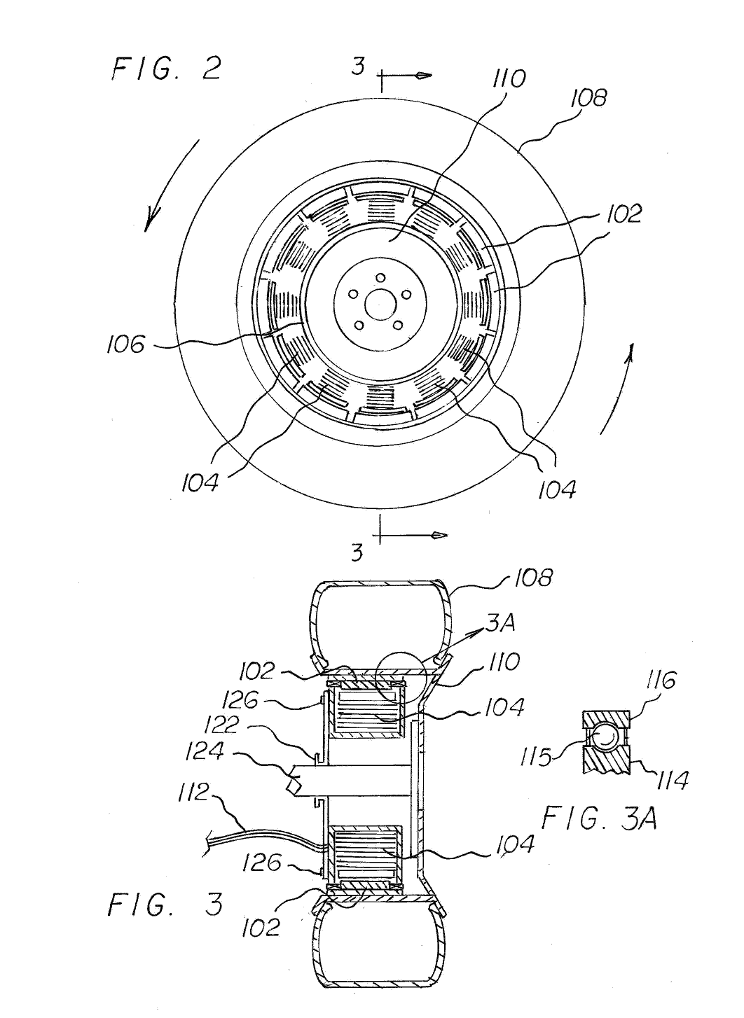

Similar to that shown in FIGS. 2 and 3, at least one roller bearing is disposed between the sleeve 101 and the annular core 104. As illustrated in FIG. 5A, the roller bearing may include a ball bearing retaining inner raceway 116 disposed on the inside surface of the sleeve 101 and an outer raceway 114 disposed on the outer surface of the annular core 103. When the raceways 114, 116 are aligned, these grooves form a circular track that contains the ball set 115.

Referring now to FIG. 5, a back plate 106 extends beyond the periphery of the annular core 103 to protect the windings 130 and bearings. An anti-rotation plate 120 may be secured to the vehicle to prevent the annular core 103 from rotating. A rubber seal and/or spacer may be inserted between the anti-rotation plate 120 and an axle 124 of the vehicle. The sleeve 101 is sealed against the back plate 106. The annular core 103 may also be secured to the axle 124 of the vehicle so that the system 100 system all moves together with the vehicle to increase shock absorption. The anti-rotation plate may be secured to the axle 124 with a half shell 126 and a stabilizing clamp.

In another particular embodiment, a method to generate electricity is disclosed. The method includes securing a plurality of permanent magnets to an inside surface of a sleeve. The sleeve is configured to fit inside a wheel rim of a vehicle and where a polarity of each magnet is opposite to an adjacent magnet. The method also includes securing windings of wire about an outer surface of an annular core in proximity to the plurality of permanent magnets, where the windings are stationary relative to the rotation of the rim. In addition, the method includes generating electrical output by rotating the permanent magnets about the windings to provide a magnetic flux to the windings.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features.

What is claimed is:

1. A system to generate electricity, the system comprising:
a sleeve configured to be secured to an inside of a wheel rim, wherein the sleeve rotates with a rotation of the wheel rim;
a plurality of permanent magnets mounted to an inside surface of the sleeve, wherein a polarity of each magnet is opposite to an adjacent magnet;
an annular core configured to slide into the sleeve and be secured to a portion of a vehicle, wherein the core is stationary relative to the rotation of the sleeve; and
a plurality of coils mounted about an outer surface of the annular core in proximity to the plurality of permanent magnets;
wherein electrical output is generated as the permanent magnets provide a magnetic flux to the plurality of coils as the sleeve rotates.

2. The system of claim 1, wherein the plurality of coils each further comprising first windings, second windings and third windings.

3. The system of claim 2, further comprising at least one roller bearing disposed between the sleeve and the annular core to maintain a desired distance between the plurality of magnets and the plurality of coils as the sleeve rotates about the annular core.

4. The system of claim 3, the roller bearing further comprising a ball bearing retaining raceway disposed on the sleeve and corresponding ball bearings disposed on the annular core.

5. The system of claim 4, further comprising a back plate adapted be secured to the annular core and to extend beyond the periphery of the annular core.

6. The system of claim 5, further comprising an anti-rotation plate secured to the vehicle and the back plate to prevent the annular core from rotating.

7. The system of claim 6, further comprising a seal between the anti-rotation plate and an axle of the vehicle.

8. The system of claim 7, further comprising a circuit board in electrical communication with the plurality of coils and an electrical system of the vehicle.

9. The system of claim 8, wherein the system is configured to be installed in an original equipment manufacturer (OEM) wheel rim.

10. The system of claim 9, wherein the plurality of coils are each wound to project outward from the annular core.

11. The system of claim 9, wherein the plurality of coils are wrapped around a periphery of the annular core.

12. The system of claim 9, wherein the sleeve is sealed against the back plate.

13. The system of claim 12, the sleeve further comprising a compression fit outer raceway channel.

14. The system of claim 13, wherein the annular core is secured to a non rotating portion of the axle of the vehicle.

15. The system of claim 14, wherein the anti-rotation plate is secured to the axle with a half shell and a stabilizing clamp.

16. A system to generate electricity, the system comprising:
a wheel rim configured to be secured to a vehicle;
a plurality of permanent magnets mounted to an inside surface of the wheel rim, wherein a polarity of each magnet is opposite to an adjacent magnet;
an annular core configured to slide into the rim and be secured to a portion of a vehicle, wherein the core is stationary relative to the rotation of the rim; and
a plurality of coils mounted about an outer surface of the annular core in proximity to the plurality of permanent magnets;
wherein electrical output is generated as the permanent magnets provide a magnetic flux to the plurality of coils as the rim rotates.

17. The system of claim 15, wherein the plurality of coils each further comprising first windings, second windings and third windings.

18. The system of claim 16, further comprising at least one roller bearing disposed between the rim and the annular core to maintain a desired distance between the plurality of magnets and the plurality of coils as the rim rotates about the annular core.

19. The system of claim 17, further comprising an anti-rotation plate secured to the vehicle and the back plate to prevent the annular core from rotating.

20. A method to generate electricity, the method comprising:
securing a plurality of permanent magnets to an inside surface of a sleeve configured to fit inside a wheel rim of a vehicle, wherein a polarity of each magnet is opposite to an adjacent magnet;
securing a plurality of coils about an outer surface of an annular core in proximity to the plurality of permanent magnets, wherein the coils are stationary relative to the rotation of the rim; and
generating electrical output by rotating the permanent magnets about the plurality of coils to provide a magnetic flux to the plurality of coils.
